(19) United States
(12) Patent Application Publication
(10) Pub. No.: US 2006/0152448 A1
(43) Pub. Date: Jul. 13, 2006

(54) Apparatus for deriving a plasma display panel

(75) Inventors: Hidekazu Hatanaka, Suwon-si (KR); Young-Mo Kim, Suwon-si (KR); Seong-Eui Lee, Suwon-si (KR); Ho-Hyeon Lee, Suwon-si (KR); Hyoung-Bin Park, Suwon-si (KR); Sang-Hun Jang, Suwon-si (KR); Gi-Young Kim, Suwon-si (KR); Seung-Hyun Song, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/313,968

(22) Filed: Dec. 22, 2005

(30) Foreign Application Priority Data
Jan. 10, 2005 (KR) 10-2005-0002047

(51) Int. Cl. G09G 3/28

(52) U.S. Cl. 345/68

(57) ABSTRACT

A driving apparatus for a plasma display panel with a pulse generator to supply an alternating pulse to an electrode, and an energy recovering unit to store charges from a discharge cell when the pulse voltage decreases or to output the stored charges to the discharge cell when the pulse voltage increases. The energy recovering unit has a magnetic switch, coupled with the discharge cell and an energy storage capacitor, with variable inductance to control transient time when the pulse transitions from a first voltage to a second voltage. The transient time is based on LC resonance of the magnetic switch inductance and panel capacitance, and can be reduced to improve resolution of the panel. Insulated gate bipolar transistors can be used with the magnetic switches to reduce power loss during switching and in the on-state, and can sustain high voltages necessary for high concentration Xe discharge gas.

### CROSS REFERENCE TO RELATED APPLICATION

This application claims priority to and benefit of Korean Patent Application No. 2005-0002047, filed on Jan. 10, 2005, which is hereby incorporated by reference for all purposes as if fully set forth herein.

### BACKGROUND OF THE INVENTION

1. Field of the Invention

The present invention relates to an apparatus for driving a display panel, and more particularly, to an apparatus for driving a display panel, by which switching losses and on-state losses can be reduced by reducing transient times of rising and falling edges of the pulses applied to electrodes of the plasma display panel.

2. Discussion of the Background

The plasma display panel is attracting increasing attention in the flat panel display market. The plasma display panel produces desired images by exciting fluorescent materials formed in a predetermined pattern by applying a discharge voltage to electrodes positioned between two substrates. The discharge voltage excites a discharge gas sealed between the substrates, and when the discharge gas returns to a lower energy state, it emits ultraviolet rays. The ultraviolet rays then collide with the fluorescent materials and excite them. When the fluoscent materials return to a lower energy state, they emit visual light of a predetermined color to form an image on the plasma display panel.

An apparatus for driving a plasma display panel creates driving signals applied to each of the electrodes so that discharge can be generated in the plasma display panel.

FIG. 1 shows a circuit diagram illustrating a conventional apparatus for driving a plasma display panel, in which a sustain pulse is applied to selected discharge cells to generate sustain discharge therein.

U.S. Pat. No. 5,081,400 discloses a conventional apparatus for driving a plasma display panel similar to the apparatus shown in FIG. 1.

For the driving apparatus of FIG. 1, it is assumed that the plasma display panel has X electrodes, Y electrodes provided in parallel with the X electrodes, and A electrodes crossing with the X and the Y electrodes. Only the driving apparatus for the X electrodes is shown in FIG. 1. The driver shown in FIG. 1 has a sustain pulse generator 10, which outputs a sustain discharge voltage Vs or a ground voltage Vg, and an energy recovering unit 20 for recovering and storing the charges output from the discharge cells after applying the sustain pulse thereto, or for outputting stored charges to the discharge cells.

The sustain pulse generator 10 has a switching element Sa coupled with a sustain discharge voltage source Vs to apply the sustain discharge voltage Vs to the discharge cells of the panel, and has a switching element Sb coupled with the ground terminal to apply the ground voltage to the discharge cells of the panel. Two switching elements Sa and Sb alternately turn on and off to apply the sustain pulse alternating between a sustain discharge voltage and a ground voltage during a sustain period.

The energy recovering unit 20 has a capacitor C for storing charges recovered from the discharge cells or outputting the stored charges to the discharge cells, switching elements Sc and Sd for determining whether the charges are to be recovered or outputted, and an inductor L for determining a pulse transient time for rising from the ground voltage to the sustain discharge voltage or falling from the sustain discharge voltage to the ground voltage by an LC resonance with the capacitance Cp in the panel.

FIG. 2 shows a timing chart illustrating a sustain pulse applied from a driver of FIG. 1.

Referring to FIG. 1 and FIG. 2, a rise time Tᵣᵢₛₑ required for the sustain pulse to rise from the ground voltage Vg to the sustain discharge voltage Vs after the switching element Sc is turned on is determined by an LC resonance generated by the inductor's inductance L and the capacitor's capacitance Cp. The rise time Tᵣᵢₛₑ is equal to π\sqrt{LC_{P}}. In addition, a fall time T_{fall} required for the sustain pulse to fall from the sustain discharge voltage Vs to the ground voltage Vg after the switching element Sd is turned on is equal to π\sqrt{LC_{P}}.

For example, if the capacitance in the panel is about 70 nF and the inductance is about 250 nH, the rise or the fall time equals 415 ns.

An exemplary sustain pulse may have a rise time Tᵣᵢₛₑ of 0.4 μs, a sustain discharge voltage time Tₜₒₚ of 1.44 μs, a fall time T_{fall} of 0.44 μs, and a ground voltage time T_{off} of 2.0 μs. As a result, the total time Tₒₙ for applying the sustain discharge voltage is 2.28 μs, and one complete cycle of the sustain pulse is 4.28 μs. Therefore, the frequency of the sustain pulse becomes 234 kHz, and the duty ratio of the sustain pulse is 53.35%. Another exemplary sustain pulse may have a rise time Tᵣᵢₛₑ of 0.3 μs, a sustain discharge voltage time Tₜₒₚ of 1.9 μs, a fall time T_{fall} of 0.3 μs, and a ground voltage time T_{off} of 2.5 μs. As a result, the total time Tₒₙ for applying the sustain discharge voltage is 2.5 μs, and one cycle of the sustain pulse is 5 μs. Therefore, the frequency of the sustain pulse becomes 200 kHz, and the duty ratio of the sustain pulse becomes 50%. Conventionally, the aforementioned sustain pulses have been used.

To efficiently perform the sustain discharge, the transient times of the rising and the falling edges of the sustain pulse should be minimized. However, due to limitations in the intrinsic material properties of the inductor with inductance L and the capacitor with capacitance Cp, conventional plasma panel displays have transient times of the rising and falling edges of the sustain pulse that are higher than desired.

Recently, a gas including a mixture of Ne or Xe has been used as a discharge gas in a plasma display panel. When a high concentration of Xe gas is used to improve luminous efficiency, a higher sustain discharge voltage is also used. However, the switching elements traditionally include metal-oxide semiconductor field effect transistors (MOSFETs). Because MOSFETs have high resistance in the switch-on state, large power losses occur during the alternating switching on and off during a sustain period. Thus, a plasma display panel driver using Xe gas and MOSFETs in the driving apparatus will consume an undesirable amount of power. This invention is therefore provided to overcome these issues in the prior art.

### SUMMARY OF THE INVENTION

This invention provides an apparatus for driving a plasma display panel, by which switching losses and on-state losses can be reduced by reducing transient times of rising and falling edges of the pulses applied to electrodes of the plasma display panel.

Additional features of the invention will be set forth in the description which follows, and in part will be apparent from the description, or may be learned by practice of the invention.

The present invention discloses an apparatus for driving a plasma display panel having a plurality of electrodes positioned between a first substrate and a second substrate. The apparatus supplies driving signals to a discharge cell, formed between the first substrate and the second substrate and where at least two electrodes cross with each other, to emit light by generating a discharge in the discharge cell. The apparatus includes a pulse generator to supply a pulse alternating between a first voltage and a second voltage to an electrode, and an energy recovering unit to store a charge from the discharge cell when the pulse decreases from the second voltage to the first voltage or to output the charge to the discharge cell when the pulse increases from the first voltage to the second voltage. The energy recovering unit has a magnetic switch with variable inductance to perform a first switching operation. Further, the magnetic switch is positioned along a current path of the charge between the energy recovery unit and the discharge cell, and the variable inductance is dependent upon a current flowing through the magnetic switch.

The present invention also discloses an apparatus for driving a plasma display panel including a plurality of first electrodes, a plurality of second electrodes disposed in parallel with the first electrodes, and a plurality of third electrodes disposed to cross with the plurality of first electrodes and the plurality of second electrodes and form discharge cells. The apparatus supplies driving signals to the discharge cells. The driving apparatus includes a sustain pulse generator to supply a sustain pulse alternating between a sustain discharge voltage and a ground voltage to at least one of the first electrodes and second electrodes to generate a sustain discharge in a discharge cell, and an energy recovering unit to store a charge from the discharge cell when the sustain pulse decreases from the sustain discharge voltage to the ground voltage or to output the charge to the discharge cell when the sustain pulse increases from the ground voltage to the sustain discharge voltage. Further, the energy recovering unit includes an energy storage capacitor to recover and store the charge from the discharge cell or to output the charge to the discharge cell, an insulated gate bipolar transistor (IGBT) to control operation of the energy storage capacitor, and a magnetic switch with variable inductance to perform a first switching operation. The magnetic switch determines a rise time required for the sustain pulse to rise from the ground voltage to the sustain discharge voltage or a fall time required for the sustain pulse to fall from the sustain discharge voltage to the ground voltage based on an LC resonance of the magnetic switch inductance and discharge cell capacitance. Additionally, the variable inductance is dependent upon a current flowing between the energy storage capacitor and the discharge cell by a switching operation of the IGBT and through the magnetic switch.

The present invention also discloses an apparatus for driving a plasma display panel with a plurality of first electrodes, a plurality of second electrodes disposed in parallel with the first electrodes, and a plurality of third electrodes disposed to cross with the plurality of first electrodes and plurality of second electrodes and form discharge cells. The apparatus supplies driving signals to the discharge cells. The apparatus includes an address pulse generator supplying an address pulse alternating between a ground voltage and an address voltage to the third electrode to generate address discharge in the discharge cells, and an energy recovering unit to store a charge from the discharge cell when the address pulse decreases from the address voltage to the ground voltage or to output the charge to the discharge cell when the address pulse increases from the ground voltage to the address voltage. Further, the energy recovering unit includes an energy storage capacitor to recover and store the charge from the discharge cell or to output the charge to the discharge cell, an insulated gate bipolar transistor (IGBT) to control operation of the energy storage capacitor, and a magnetic switch with variable inductance to perform a first switching operation. The magnetic switch determines a rise time required for the address pulse to rise from the ground voltage to the address voltage or a fall time required for the address pulse to fall from the address voltage to the ground voltage based on an LC resonance of the magnetic switch inductance and discharge cell capacitance. Additionally, the variable inductance is dependent upon a current flowing between the energy storage capacitor and the discharge cell by a switching operation of the IGBT and through the magnetic switch.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a circuit diagram illustrating a conventional driving apparatus for a plasma display panel and for supplying a sustain pulse to generate sustain discharge in desired discharge cells.

FIG. 2 shows a timing diagram illustrating a sustain pulse applied to the driver of FIG. 1.

FIG. 3 shows a perspective view illustrating an exemplary plasma display panel which is driven by a driving apparatus according to the present invention.

FIG. 4 shows a schematic diagram illustrating an electrode arrangement in a plasma display panel of FIG. 3.

FIG. 5 shows a block diagram illustrating a driving apparatus for a plasma display panel of FIG. 3.

FIG. 6 shows an address-display separation drive method for the Y electrodes as an example of a method of driving a plasma display panel of FIG. 3.

FIG. 7 shows a timing chart illustrating an example of driving signals output from the drivers of FIG. 5 according to the present invention.

FIG. 8 shows a circuit diagram illustrating an apparatus for driving a plasma display panel according to an embodiment of the present invention.

FIG. 9 shows a graph illustrating a hysteresis curve representing relationship between magnetic flux density and magnetic field intensity in a magnetic switch of FIG. 8.

FIG. 10 shows characteristics of each switching element of FIG. 8 according to a material type.

FIG. 11 shows a timing chart illustrating an example of a sustain pulse applied from the driver of FIG. 8.

FIG. 12 shows a circuit diagram illustrating an apparatus for driving a plasma display panel according to another embodiment of the present invention, in which a Y driver is shown.

FIG. 13 shows a circuit diagram illustrating an apparatus for driving a plasma display panel according to still another embodiment of the present invention, in which an A driver is shown.

FIG. 14 shows a timing chart of an address pulse generated from the driver of FIG. 13.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

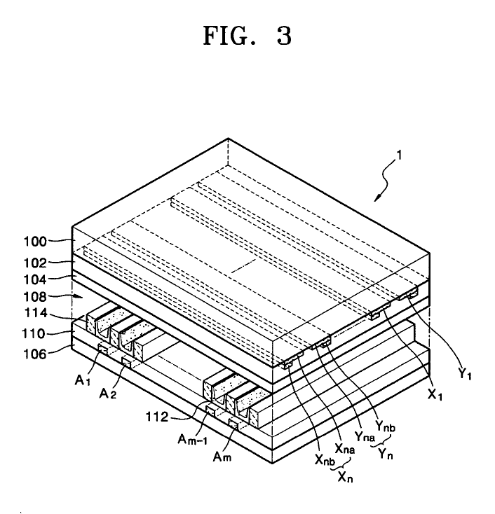

FIG. 3 shows a perspective view of an exemplary plasma display panel which is driven by an apparatus according to the present invention.

Address electrodes A₁ through Aₘ, first dielectric layer 102 and second dielectric layer 110, Y electrodes Y₁ through Yₙ, X electrodes X₁ through Xₙ, a fluorescent layer 112, partition walls 114, and a protection layer 104 are arranged between a first substrate 100 and a second substrate 106 of the plasma display panel.

The Address electrodes A₁ through Aₘ are formed on the second substrate 106 in a predetermined pattern facing the first substrate 100. The Address electrodes A₁ through Aₘ may be formed of a conductive metal such as Ag, Al, or Cu.

The second dielectric layer 110 can be formed to cover the Address electrodes A₁ through Aₘ. On the second dielectric layer 110, the partition walls 114 can be formed in parallel with the Address electrodes A₁ through Aₘ. The second dielectric layer 110 can be formed of a dielectric material, such as PbO, B₂O₃, or SiO₂, which is capable of attracting wall charges and protecting the Address electrodes from being damaged by positive ions or electrons.

The partition walls 114 partition discharge regions for each discharge cell and prevent optical interference between adjacent discharge cells. Although FIG. 3 shows the partition walls 114 as arranged in a stripe pattern, the present invention is not limited thereto, and can be implemented in a variety of forms, such as matrix, waffle, or delta. In addition, the cross-sectional shape of the discharge space may be circular, elliptical, or polygonal including rectangular, triangular, or pentagonal.

The fluorescent layer 112 can be formed on the second dielectric layer 110 over the Address electrodes A₁ through Aₘ between the partition walls 114. The fluorescent layer 112 may include a red-color fluorescent layer, a green-color fluorescent layer, and a blue-color fluorescent layer, arranged sequentially. The red-color fluorescent layer may be made from Y(V,P)O₄:Eu, the green-color fluorescent layer may be made from Zn₂SiO₄:Mn or YBO₃:Tb, and the blue-color fluorescent layer may be made from BAM:Eu.

The X electrodes X₁ through Xₙ and the Y electrodes Y₁ through Yₙ are formed on the first substrate 100 facing the second substrate 106 in a predetermined pattern and crossing with the Address electrodes A₁ through Aₘ. Discharge cells are positioned where the electrodes cross. The X electrodes X₁ through Xₙ and the Y electrodes Y₁ through Yₙ may be formed by combining a transparent conductive material (Xna and Yna) such as indium tin oxide (ITO) with a metallic electrode (Xnb and Ynb) to increase conductivity of the X electrodes and the Y electrodes.

The first dielectric layer 102 can be formed to cover the X electrodes X₁ through Xₙ arid the Y electrodes Y₁ through Yₙ. The first dielectric layer 102 can be formed of a dielectric material, such as PbO, B₂O₃, and SiO₂, which is capable of attracting wall charges and protecting the X electrodes and the Y electrodes from being damaged by positive ions or electrons.

The protection layer 104 can be formed of, for example, MgO to cover the entire surface of the first dielectric layer 102. The protection layer 104 protects the panel from the high electric field inside the discharge cells. The protection layer 104 may be formed by depositing a thin film through sputtering, or electron-beam evaporation.

A discharge gas such as Ne, Xe, or a mixture thereof is sealed in the discharge space 108.

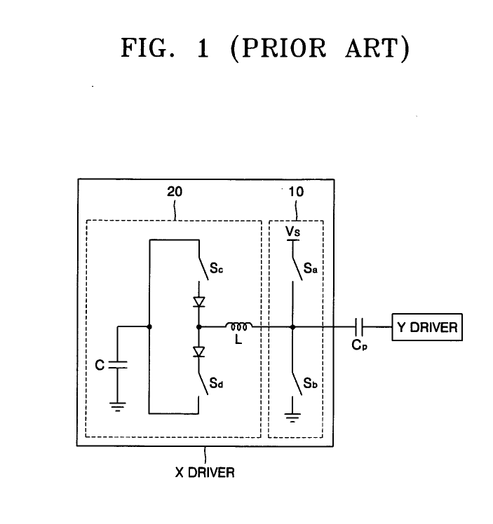

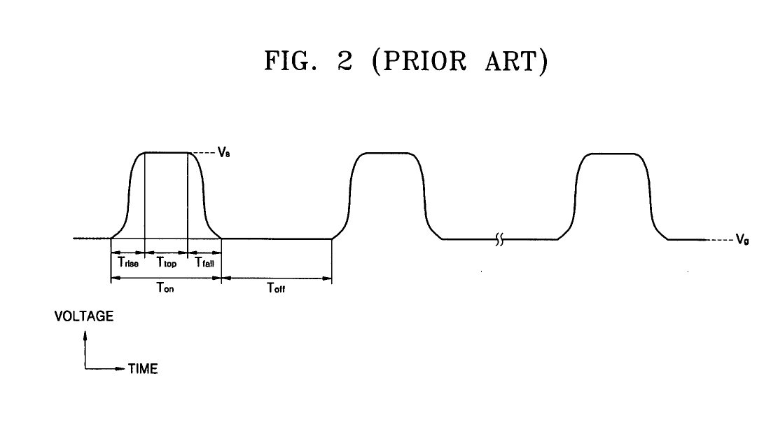

The present invention is not limited to the plasma display panel structure shown in FIG. 1.

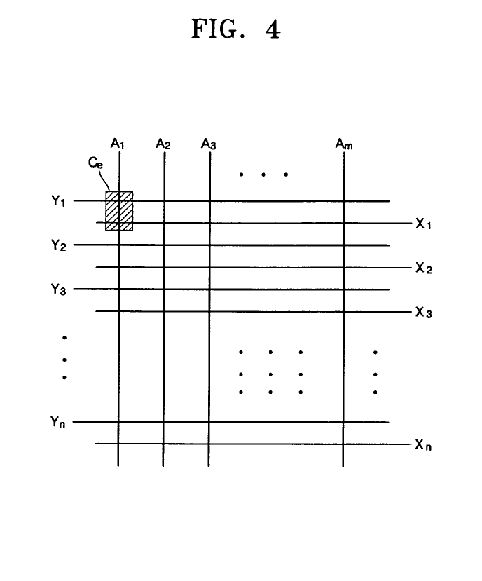

FIG. 4 shows a schematic diagram illustrating an electrode arrangement of a plasma display panel of FIG. 3.

The Y electrodes Y₁ through Yₙ and the X electrodes X₁ through Xₙ are positioned alternately and in parallel with each other, and the Address electrodes A₁ through Aₘ are arranged to cross with the X electrodes X₁ through Xₙ and the Y electrodes Y₁ through Yₙ. A discharge cell Ce is formed to correspond with the region where the electrodes cross with each other.

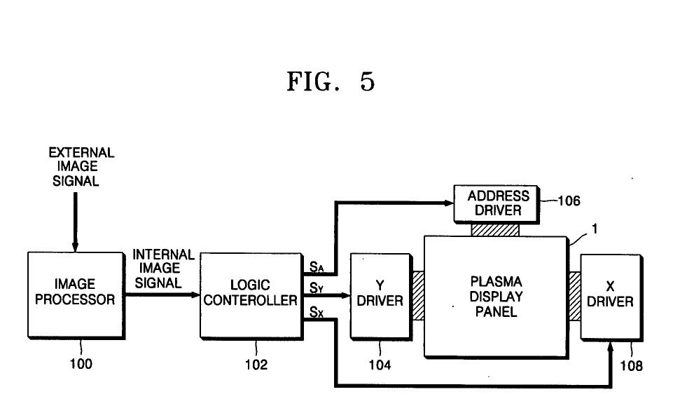

FIG. 5 shows a block diagram of a driving apparatus for the 3-electrode type plasma display panel shown in FIG. 3.

The driving apparatus shown in FIG. 5 includes an image processor 100, a logic controller 102, a Y driver 104, an address driver 106, an X driver 108, and a plasma display panel 1.

The image processor 100 receives external analog image signals from an external source such as a personal computer, a DVD, a video player, or a television set, converts the analog signals into digital signals, and processes the digital signals to output internal image signals. The internal image signals can includes red, green, and blue image signals of 8 bits, clock signals, and vertical and horizontal synchronization signals.

The logic controller 102 receives the internal image signals, performs various processes such as a gamma correction and an automatic power control, and outputs an address drive control signal S_{A}, a Y drive control signal S_{Y}, and an X drive control signal S_{X}.

The Y driver 104, the Address driver 106, and the X driver 108 receive the respective drive control signals, and output drive signals to Y electrodes, the Address electrodes, and X electrodes of the plasma display panel 1, respectively.

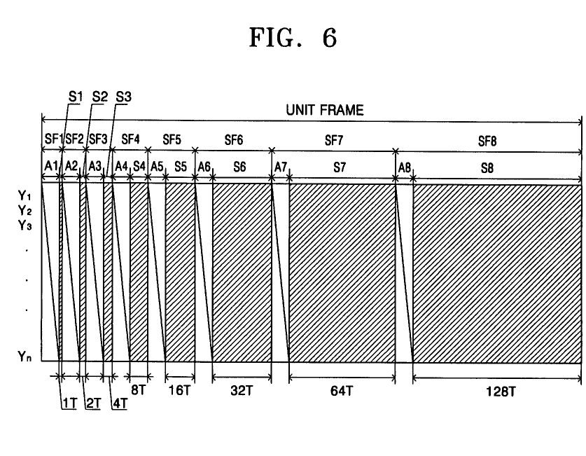

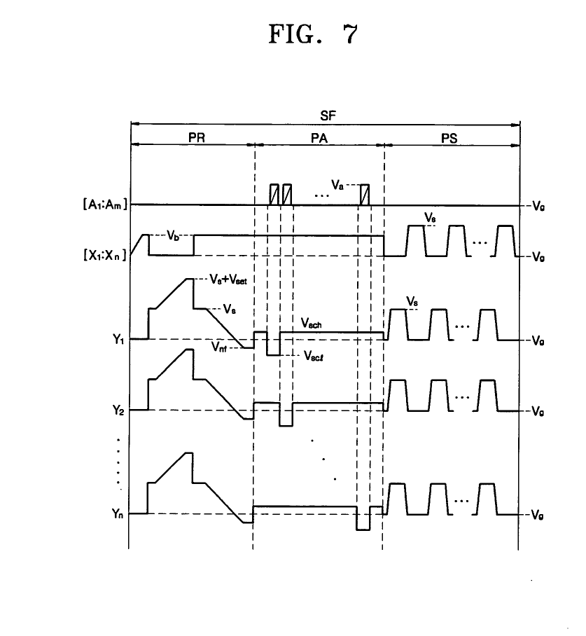

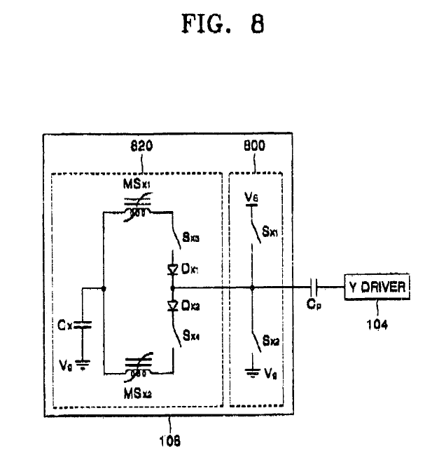

FIG. 6 shows an address-display separation drive method for the Y electrodes as an example of a method of driving a plasma display panel shown in FIG. 3.

A unit frame may be divided into multiple sub-fields, shown in FIG. 6 as SF1 through SF8, to implement a time-division gradient. Each sub-field can be divided into a reset interval (not shown), an address interval, shown as A1 through A8, and a sustain discharge interval, shown as S1 through S8.

In each address interval A₁ through A₈, address pulses are applied to the address electrodes A₁ through Aₘ, and scan pulses are simultaneously and sequentially applied to corresponding Y electrodes Y₁ through Yₙ in cells to be addressed or turned on. Application of the scan pulses in these cells results in address discharge and, therefore, accumulation of walls charges in these cells.

In a sustain discharge interval, such as the sustain discharge intervals S₁ through S₈, sustain pulses are alternately applied to the Y electrodes Y₁ through Yₙ and the X electrodes X₁ through Xₙ, so that the sustain discharge is generated in the discharge cells where wall charges accumuluated in the preceding address interval.

The luminance of the plasma display panel is determined by the total number of the sustain discharge pulses within the sustain discharge intervals S1 through S8 of a unit frame. In an embodiment where one image is represented by one frame with 8 sub-fields and 256 gradient levels, a different number of sustain pulses, for example, 1, 2, 4, 8, 16, 32, 64, or 128, may be allocated to each sub-field. For example, to obtain a gradient level of 133, the cells are addressed to perform one sustain discharge during the first sub-field SF1, four sustain discharges during the third sub-field SF3, and one hundred twenty-eight sustain discharges during the eighth sub-field SF8.

The number of sustain discharge pulses allocated to each sub-field may be varied by the weight of the sub-field according to the automatic power control (APC) process. In addition, the number of sustain discharge pulses allocated to each sub-field may be modified to account for individual panel properties and gamma properties. For example, the gradient level allocated to the fourth sub-field SF4 may be decreased from 8 to 6, and the gradient level allocated to the sixth sub-filed SF6 may be increased from 32 to 34. In addition, the number of sub-fields constituting one frame may be modified to suit particular design requirements.

FIG. 7 shows a timing chart illustrating an example of driving signals output from the Address driver, Y driver, and X driver shown on FIG. 5 according to the present invention.

In order to drive the plasma display panel 1, a unit frame corresponding to one image is divided into a plurality of sub-fields, and each sub-field SF is divided into a reset period PR, an address period PA, and a sustain period PS.

First, during the reset period PR, a gradually rising and gradually falling reset pulse is applied to the Y electrodes Y₁ through Yₙ. A positive bias voltage Vb is applied to the X electrodes X₁ through Xₙ when the reset pulse transitions from gradually rising to gradually falling. The positive bias voltage Vb generates a reset discharge in all discharge cells, and the reset discharge initializes the discharge cells in preparation for a subsequent address period. The gradually rising portion of the reset pulse increases from the sustain discharge voltage Vs by an additional reset voltage Vset, so that the reset pulse has a maximum voltage equal to Vset+Vs. The gradually falling portion of the reset pulse decreases from the sustain discharge voltage Vs to a minimum voltage Vnf.

During the address period PA, the scan pulses are sequentially applied to the Y electrodes Y₁ through Yₙ, and the address pulses are applied to Address electrodes A1 through Am that correspond to the Address electrodes to generate an address discharge. The address discharge addresses or selects the discharge cells where the sustain discharge will happen during the subsequent sustain period PS. The Y electrodes are biased with a scan high voltage Vsch, and scan pulses with scan low voltage Vscl are applied in cells to be selected. Simultaneously, an address pulse with a positive address voltage Va is applied to an address electrode in a discharge cell to be selected. Thus, within a discharge cell to be selected, the address pulse is applied in synchronization with the scan pulse.

During the sustain period PS, the sustain pulses are alternately applied to the X electrodes X₁ through Xₙ and the Y electrodes Y₁ through Yₙ to generate a sustain discharge. Through the sustain discharge, a luminance depends upon the gradient weight allocated to the sub-field in which sustain discharge is occurring. The sustain pulses can alternate between a sustain discharge voltage Vs and a ground voltage Vg.

The waveforms of the driving signals other than those shown in FIG. 7 may be output from each drivers of FIG. 5, and the present invention is not limited to the waveforms shown in FIG. 7.

FIG. 8 shows a circuit diagram illustrating an apparatus for driving a plasma display panel according to an embodiment of the present invention.

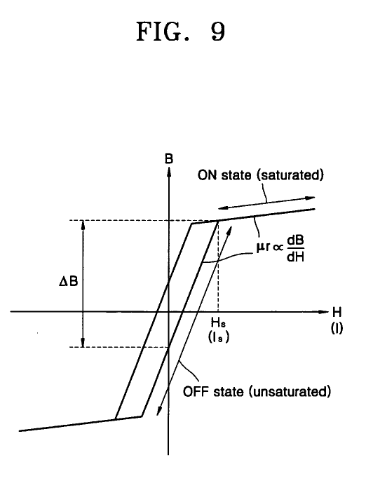

FIG. 9 is a graph illustrating a hysteresis curve representing relationship between magnetic flux density and magnetic field intensity in a magnetic switch of FIG. 8.

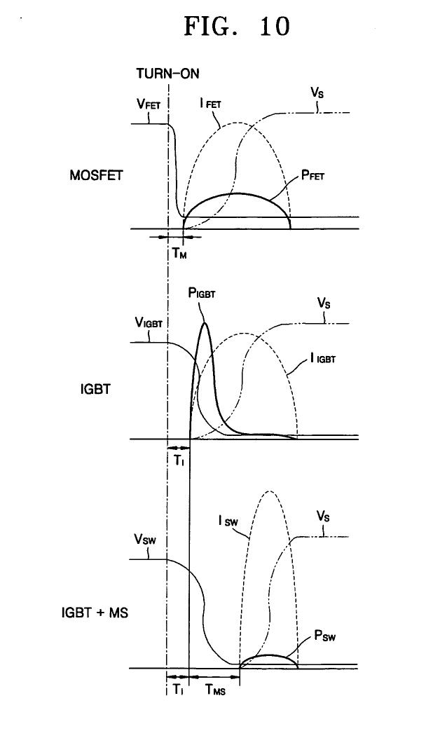

FIG. 10 illustrates characteristics of each switching element of FIG. 8 according to a material type.

Referring to FIG. 7 through FIG. 10, the driver of the plasma display panel shown in FIG. 8 schematically illustrates the X driver of FIG. 5.

The X driver 108 includes a sustain pulse generator 800 and an energy recovering unit 820.

The sustain pulse generator 800 provides a sustain pulse, which will be applied to an X electrode of the panel to perform the sustain discharge in selected discharge cells. The sustain pulse may alternate between the sustain discharge voltage Vs and the ground voltage Vg. Therefore, the sustain pulse generator 800 includes a sustain discharge voltage source Vs for supplying the sustain discharge voltage Vs; a first switching element S_{X1} coupled with the sustain discharge voltage source Vs and an X electrode of the panel (where an X electrode is shown as a first terminal of capacitor Cp, a Y electrode is the second terminal of the capacitor Cp, and the Y electrode is coupled with the Y Driver 104); a ground terminal supplying a ground voltage Vg; and a second switching element S_{X2} coupled with the ground terminal and the X electrode of the panel.

The energy recovering unit 820 recovers charges from the discharge cells when the sustain pulse rises from the ground voltage Vg to the sustain discharge voltage Vs, or outputs the stored charges to the discharge cells when the sustain pulse falls from the sustain discharge voltage Vs to the ground voltage Vg. The energy recovering unit 820 includes a first magnetic switch MS_{X1} and a second magnetic switch MS_{X2}, a third switching element S_{X3} and a fourth switching element S_{X4}, and an energy storage capacitor Cₓ. In FIG. 8, the energy storage capacitor Cₓ is coupled with the first magnetic switch MS_{X1} and second magnetic switch MS_{X2} in parallel. The first magnetic switch MS_{X1} is coupled with the third switching element S_{X3}, and the second magnetic switch MS_{X2} is coupled with the fourth switching element S_{X4}. The third switching element S_{X3} and fourth switching element S_{X4} are coupled with the X electrode of the panel via the first diode D_{X1} and the second diode D_{X2}, respectively, included to prevent over-voltage.

The energy storage capacitor Cₓ recovers and stores charges remaining in the X electrode after the sustain discharge or outputs the stored charges to the X electrode.

The third switching element S_{X3} and fourth switching element S_{X4} turn on or turn off to create a path for the charges stored in the energy storage capacitor Cₓ to flow to the X electrode, or for the charges in the X electrode to be recovered by the storage capacitor Cₓ.

The first magnetic switch MS_{X1} is coupled with the third switching element S_{X3}. When the third switching element S_{X3} is turned on, the inductance of the first magnetic switch MS_{X1} varies according to the current flowing from the energy storage capacitor Cₓ to the X electrode. Further, the second magnetic switch MS_{X2} is coupled with the fourth switching element S_{X4}. When the fourth switching element S_{X4} is turned on, the inductance of the second magnetic switch MS_{X2} varies according to the current flowing from the X electrode to the energy storage capacitor Cₓ. The varying inductance induces a counter electromotive force, and the counter electromotive force interferes with the current flow, thereby performing a switching operation. In addition, the variable inductance is used to determine the transient time of the sustain pulse based on the LC resonance of the inductance of the first magnetic switch MS_{X1} or second magnetic switch MS_{X2} and the capacitance Cp of the panel when the first magnetic switch MS_{X1} or the second magnetic switch MS_{X2} is turned on.

Typically, a magnetic switch can include a ferromagnetic core and a coil wound around the core. The counter electromotive force induced in the magnetic switch is proportional to the inductance (refer to Equation 2, which will be described below) and thus varies as the inductance of the magnetic switch changes. Further, the magnetic switch inductance changes depending on the amount of the current flowing through the magnetic switch.

FIG. 9 shows a graph illustrating a hysteresis curve representing relationship between magnetic flux density and magnetic field intensity in a magnetic switch. This graph shows why the inductance changes depending on the amount of the current flowing through the magnetic switch.

$${L}_{MS} = μ r {μ}_{0} \frac{{A}_{m}}{{l}_{m}} {N}_{t}^{2} \qquad [ Equation 1 ]$$

where, L_{MS} is inductance of a magnetic switch, μₒ is magnetic permeability in a vacuum, μr is a specific permeability against the magnetic permeability in a vacuum, Am is a cross-sectional area of a core, 1 m is a path length of a magnetic field, and Nt is the winding number of the coil.

$${V}_{Ms} = - {L}_{MS} \frac{ⅆ l}{ⅆ t} \qquad [ Equation 2 ]$$

where, I is the amount of the current flowing through the magnetic switch and t is time. Therefore, dI/dt is the change in current per change in time.

Referring to Equation 1, equation 2, and FIG. 9, magnetic field intensity H is on the horizontal axis, and magnetic flux density B is on the vertical axis. The magnetic field intensity H is proportional to the amount of the current I flowing through the coil of the magnetic switch. In FIG. 9, when the magnetic field intensity H is larger than a critical value Hs, the magnetic flux density rate of change, ΔB on FIG. 9, is remarkably reduced in comparison to where the magnetic field intensity H is smaller than the critical value Hs. This phenomenon is called “saturation” of the magnetic flux density. Since the specific permeability μr is proportional to the rate of change of the magnetic flux density per the rate of change of the magnetic field intensity, dB/dH, the specific permeability μr also significantly decreases where H exceeds the critical value Hs of the magnetic field intensity H. For example, the specific permeability μr can be about 1000˜100000 when the magnetic flux density is unsaturated, whereas the specific permeability μr can be about 1 when the magnetic flux density is saturated. Since the counter electromotive force is proportional to the specific permeability μr, the counter electromotive force V_{MS} is also reduced by a factor of up to 100000 in the saturated zone. Therefore, the current cannot exceed the counter electromotive force V_{MS} and cannot flow through the magnetic switch when the magnetic flux density is unsaturated. However, the current can exceed the counter electromotive force V_{MS} and can flow through the magnetic switch when the magnetic flux density is saturated. As a result, a switching operation can be performed by transitioning the magnetic switch from the unsaturated to saturated zone.

The inductance L_{MS} of the magnetic switch in the saturated zone is determined by Equation 1. Thus, the inductance of the magnetic switch is proportional to the specific permeability in the saturated zone, the cross-sectional area Aₘ of the core, and the square Nt² of the winding number of the coil, and inversely proportional to the path length 1 m of the magnetic field. Since the specific permeability in the saturated zone is much smaller than the specific permeability in the unsaturated zone, the inductance in the saturated zone is also much smaller than the inductance in the unsaturated zone. Desired inductance can be further obtained by selecting a desired cross-sectional area Am of the coil, the winding number Nt of the coil, and the path length lm of the magnetic field.

The switching timing of the magnetic switch is determined by the magnetic field intensity H, which is proportional to the amount of the current flowing through the magnetic switch. Therefore, it is necessary to determine the switching timing in a design procedure. While the magnetic switch described above is passive during operation, it has little possibility of malfunctioning or becoming damaged due to its structural characteristic.

An insulated gate bipolar transistor (IGBT) can be used as the third switching element S_{X3} or the fourth switching element S_{X4}.

FIG. 10 illustrates switching characteristics of the MOSFET, IGBT, and IGBT+Magnetic Switch (MS).

Table 1 provides a list of switching characteristics, specifically the switching power loss and the on-state power loss, of the MOSFET, IGBT, and IGBT+MS.

TABLE 1

| | |
|---|---|
| switching | loss |

| element | Switching loss | On-state loss |
|---|---|---|
| MOSFET | Small | Large |
| IGBT | Large | small |
| IGBT + MS | small | Small |

Referring to Table 1 and FIG. 10, the MOSFET responds most quickly to the turn-on signal (i.e., a control signal applied to turn on the switch) after a time period T_{M} and has a small switching loss. However, since the MOSFET has relatively high on-state resistance after being turned on, its on-state power loss is also large.

Conversely, the IGBT responds to the turn-on signal after a time period T₁, which occurs later than T_{M} of the MOSFET. Further, the IGBT has a large switching loss because its switching resistance is high. However, since the IGBT has relatively low on-state resistance after being turned on, its on-state power loss is small in comparison to the MOSFET. Therefore, unlike the MOSFET, the IGBT can be used for high voltage switching. Since a high concentration of Xe gas has been used recently to to improve discharge efficiency of plasma display panel, and a high voltage is applied to drive the high concentration Xe gas, the IGBT has useful on-state characteristics for a plasma display panel with high concentration Xe discharge gas.

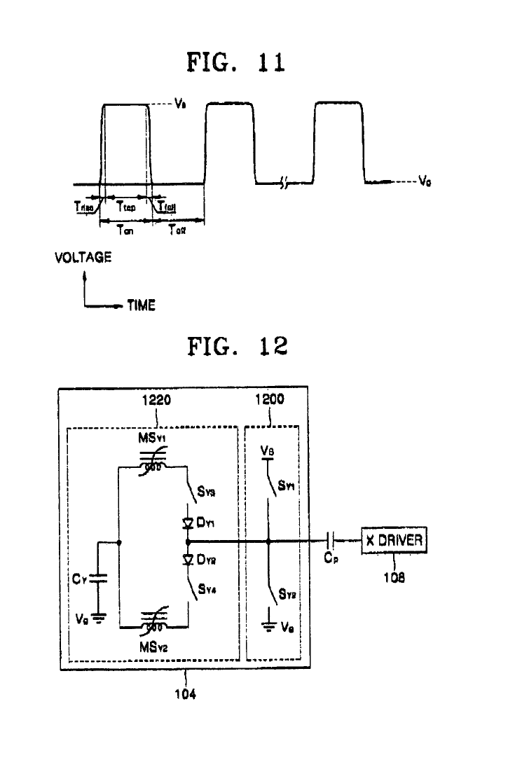

The IGBT+MS with switching characteristics shown in FIG. 10 and Table 1 corresponds to the circuit shown in FIG. 8. The IGBT+MS circuit possesses the merits of the MOSFET as well as merits of the IGBT. Specifically, the magnetic switch (MS) turns on based upon the amount of the current flowing through the MS after the IGBT is turned on. Therefore, the IGBT+MS has a small switching loss as well as a small on-state loss. Additionally, like the IGBT when used alone, the IGBT+MS can be used for high voltage switching. However, since the IGBT turns on after a predetermined time period T₁, and the MS turns on only after the current flowing through the MS reaches a critical value Is (which corresponds to the magnetic field intensity critical value Hs shown in FIG. 9) after a time period T_{MS}, the IGBT should be turned on at least a time period T_{MS} early to apply the waveform of the sustain pulse shown in FIG. 11.

FIG. 11 shows a timing chart illustrating an example of a sustain pulse applied by the driver shown in FIG. 8.

Referring to FIG. 8, FIG. 9, FIG. 10, and FIG. 11, the rise time Tᵣᵢₛₑ required for the sustain pulse to increase from the ground voltage Vg to the sustain discharge voltage Vs after the first magnetic switch MS_{X1} and the IGBT S_{X3} are turned on is determined by the LC resonance created by the inductance L_{MSX1} of the first magnetic switch MS_{X1} and the capacitance Cp of the panel. The rise time Tᵣᵢₛₑ equals π\sqrt{L_{MSX1}C_{P}}. The fall time T_{fall} required for the sustain pulse to decrease from the sustain discharge voltage Vs to the ground voltage Vg after the second magnetic switch MS_{X2} and the IGBT S_{X4} are turned on is determined by the LC resonance created by the inductance L_{MSX2} of the second magnetic switch MS_{X2} and the capacitance Cp of the panel. The fall time T_{fall} equals a π\sqrt{L_{MSX2}C_{P}}.

For example, if the capacitance of the panel is 70 nF, and the inductance of the first magnetic switch or second magnetic switch is 28 nH, the rise time Tᵣᵢₛₑ or the fall time T_{fall}, respectively, equals 138 ns. If the capacitance of the panel is 70 nF, and the inductance of the first magnetic switch or second magnetic switch is 7 nH, the rise time Tᵣᵢₛₑ or the fall time T_{fall}, respectively, equals 69 ns.

A first exemplary sustain pulse generated in the X driver shown in FIG. 8 may have a rise time Tᵣᵢₛₑ of 0.05 μs, a sustain discharge voltage time of 1.44 μs, a fall time T_{fall} of 0.05 μs, and a ground voltage time T_{off} of 1.54 μs. Thus, the time Tₒₙ for applying the sustain discharge voltage Vs in the sustain pulse is 1.54 μs, and a cycle of the sustain pulse is 3.08 μs. Therefore, the sustain pulse has a frequency of 325 kHz, and a duty ratio of about 50%. In comparison with a conventional sustain pulse, a cycle of the sustain pulse can be reduced by approximately 28%, from 4.28 μs to 3.08 μs.

A second exemplary sustain pulse generated in the X driver shown in FIG. 8 may have a rise time Tᵣᵢₛₑ of 0.05 μs, a sustain discharge voltage time of 1.9 μs, a fall time T_{fall} of 0.05 μs, and a ground voltage time T_{off} of 2.0 μs. Thus, the time Tₒₙ for applying the sustain discharge voltage Vs in the sustain pulse is 2.0 μs, and a cycle of the sustain pulse is 4.0 μs.

Therefore, the sustain pulse has a frequency of 250 kHz, and a duty ratio of about 50%. In comparison with a conventional sustain pulse, a cycle of the sustain pulse can be reduced by approximately 20%, from 5 μs to 4 μs.

As a result, the duration of a sustain pulse can be reduced, and thus, the duration of the sustain period PS, as shown in FIG. 7, can also be reduced. When the duration of the sustain period PS is reduced by a quantity of time, the duration of the address period PA or the reset period PR can be increased by the same quantity of time. Either alternatively or additionally, the number of sub-fields allocated to a unit frame could be increased. For example, since the number of the scanning (Y) electrode lines and the sustain (X) electrode lines has been increasing in recent high resolution plasma display panels, the address period for sequentially scanning the increased number of lines may be extended in duration as necessary. The increased duration of the address period PA can be compensated to result in a zero net time change for displaying one frame of an image by reducing the rise time Tᵣᵢₛₑ and the fall time T_{fall} of each wave of the sustain pulse. Either alternatively or additionally, the gradient level displayed in each cell could be increased beyond 256 by adding sub-fields. Thus, the plasma display panel could display a higher resolution.

The operation of the X driver of FIG. 8 will now be described with reference to FIG. 11. When third switching element S_{X3} turns on, the current starts to flow from the energy storage capacitor Cₓ to the panel. Then, the first magnetic switch MS_{X1} turns on when the current exceeds the critical value Is, and the sustain pulse increases from the ground voltage Vg to the sustain discharge voltage Vs. The first switching element S_{X1} of the sustain pulse generator 800 then turns on, and the third switching element S_{X3} turns off, so that the sustain pulse maintains the sustain discharge voltage Vs. Then, after a period of time Ttop, the first switching element S_{X1} turns off, and the fourth switching element SX4 turns on, so that the current starts to flow from the panel to the energy storage capacitor Cₓ. The second magnetic switch MS_{X2} turns on when the current exceeds the critical value Is, and the sustain pulse decreases from the sustain discharge voltage Vs to the ground voltage Vg. Then, the second switching element S_{X2} of the sustain discharge generator 800 turns on, and the fourth switching element S_{X4} turns off, so that the sustain pulse maintains the ground voltage Vg.

The X driver is not limited to the structure shown in FIG. 8, but can include a bias voltage generator for applying a bias voltage Vb to an X electrode as shown in FIG. 7. The bias voltage generator may include a bias voltage source and a switching element to apply the bias voltage to the panel by a switching operation of the switching element.

FIG. 12 shows a circuit diagram illustrating an apparatus for driving a plasma display panel according to another embodiment of the present invention, in which a Y driver is shown.

The circuit shown in FIG. 12 is similar to that shown in FIG. 8. Referring to FIG. 7 through FIG. 12, the circuit shown in FIG. 12 can be a Y driver for applying the sustain pulse to a Y electrode, shown as a first terminal of the capacitor Cp. The second terminal of the capacitor Cp is an X electrode coupled with an X driver 108. The Y driver includes a sustain pulse generator 1200 and an energy recovering unit 1220.

The sustain pulse generator 1200 includes a sustain discharge voltage source Vs coupled with a first switching element S_{Y1} for applying the sustain discharge voltage Vs to the Y electrode, a ground terminal coupled with a second switching element S_{Y2} for applying the ground voltage Vg to the Y electrode.

The energy recovering unit 1220 includes a first magnetic switch MS_{Y1} and a second magnetic switch MS_{Y2}, a third switch S_{Y3} and a fourth switch S_{Y4}, and an energy storage capacitor C_{Y}. The energy storage capacitor C_{Y} is coupled with the first magnetic switch MS_{X1} and second magnetic switch MS_{X2} in parallel. The first magnetic switch MS_{Y1} is coupled with the third switching element S_{Y3}, and the second magnetic switch MS_{Y2} is coupled with the fourth switching element S_{Y4}. The third switching element S_{Y3} and the fourth switching element S_{Y4} are coupled with the Y electrode of the panel via the first diode D_{Y1} and the second diode D_{Y2}, respectively, included to prevent over-voltage. The third switching element S_{Y3} and the fourth switching element S_{Y4} can be IGBTs.

The operation of the driver of FIG. 12 will now be described with reference to the is FIG. 11. When the third switching element S_{Y3} turns on, the current starts to flow from the energy storage capacitor C_{Y} to the panel Cp. Then, the first magnetic switch MS_{Y1} turns on when the current exceeds the critical value Is, and the sustain pulse increases from the ground voltage Vg to the sustain discharge voltage Vs by the LC resonance of the inductance L_{MSY1} of the first magnetic switch MS_{Y1} and the capacitance Cp of the panel. The rise time Tᵣᵢₛₑ required for the sustain pulse to rise from the ground voltage Vg to the sustain discharge voltage Vs equals π\sqrt{L_{MSY1}C_{P}}. Then, the third switching element S_{Y3} turns off, and the first switching element S_{Y1} turns on, so that the sustain pulse is maintained at the sustain discharge voltage Vs. Then, after a period of time Ttop, the first switching element S_{Y1} turns off, and the fourth switching element S_{Y4} turns, so that the current starts to flow from the panel to the energy storage capacitance C_{Y}. The second magnetic switch MS_{Y2} turns on when the current exceeds the critical value Is, and the sustain pulse decreases from the sustain discharge voltage Vs to the ground voltage Vg by the LC resonance of the inductance L_{MSY2} of the second magnetic switch MS_{Y2} and the capacitance Cp of the panel. The fall time T_{fall} required for the sustain pulse to decrease from the sustain discharge voltage Vs to the ground voltage Vg equals π\sqrt{L_{MSY12}C_{P}}. Then, the fourth switching element S_{Y4} turns off, and the second switching element S_{Y2} of the sustain pulse generator 1200 turns on, so that sustain pulse maintains the ground voltage Vg.

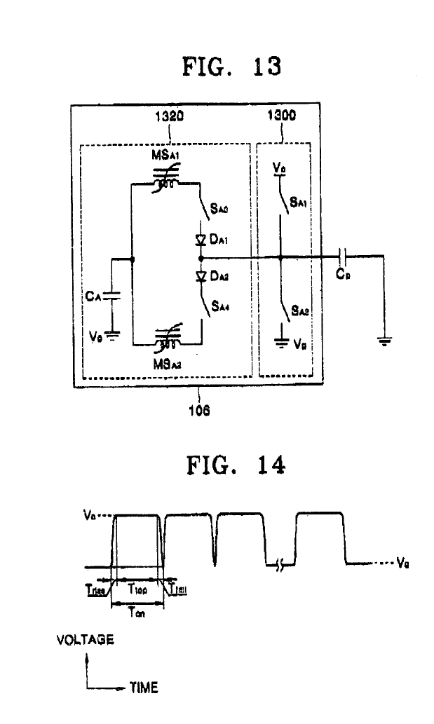

FIG. 13 shows a circuit diagram illustrating an apparatus for driving a plasma display panel according to still another embodiment of the present invention, in which an Address driver is shown.

FIG. 14 shows a timing chart of an address pulse generated from the driver of FIG. 13.

The circuit shown in FIG. 13 is similar to that shown in FIG. 8. Referring to FIG. 7, FIG. 13, and FIG. 14, the circuit shown in FIG. 13 is an Address driver for applying the address pulse to an Address electrode. The Address driver includes an address pulse generator 1300 and an energy recovering unit 1320.

The address pulse generator 1300 includes an address voltage source Va coupled with a first switching element S_{A1} for applying the address voltage to the address electrode, a ground terminal coupled with a second switching element S_{A2} for applying the ground voltage Vg to the address electrode.

The energy recovering unit 1320 includes a first magnetic switch MS_{A1} and a second magnetic switch MS_{A2}, a third switch S_{A3} and a fourth switch S_{A4}, and an energy storage capacitor C_{A}. The energy storage capacitor C_{A} is coupled with the first magnetic switch MS_{A1} and a second magnetic switch MS_{A2} in parallel. The first magnetic switch MS_{A1} is coupled with the third switching element SA₃, and the second magnetic switch MS_{A2} is coupled with the fourth switching element S₄. The third switching element S_{A3} and the fourth switching element S_{A4} are coupled with the A electrode of the panel via the first diode D_{A1} and the second diode D_{A2}, respectively, included to prevent over-voltage. The third switching element S_{A3} and the fourth switching element S_{A4} can be IGBTs.

The operation of the Address driver of FIG. 13 will now be described with reference to FIG. 14. When the third switching element S_{A3} turns on, the current starts to flow from the energy storage capacitor C_{A} to the panel Cp. Then, the first magnetic switch MS_{A1} turns on when the current exceeds the critical value Is, and the address pulse increases from the ground voltage Vg to the address voltage by the LC resonance of the inductance L_{MSA1} of the first magnetic switch MS_{A1} and the capacitance Cp of the panel. The rise time Tᵣᵢₛₑ required for the address pulse to rise from the ground voltage to the address voltage Va equals π\sqrt{L_{MSA1}C_{P}}. Then, the third switching element S_{A3} turns off, and the first switching element S_{A1} of the address pulse generator 1300 turns on, so that the address pulse is kept at the address voltage. Then, after a period of time Ttop, the first switching element S_{A1} turns off, and the fourth switching element S_{A4} turns on, so that the current starts to flow from the panel to the energy storage capacitance C_{A}. The second magnetic switch MS_{A2} turns on when the current exceeds the critical value Is, and the address pulse decreases from the address voltage Va to the ground voltage Vg by the LC resonance of the inductance L_{MSA2} of the second magnetic switch MS_{A2} and the capacitance Cp of the panel. The fall time T_{fall} required for the address pulse to decrease from the address voltage to the ground voltage equals π\sqrt{L_{MSA2}C_{P}}. Then, the fourth switching element S_{A4} turns off, and the second switching element S_{A2} of the address pulse generator 1300 turns on, so that the address pulse maintains the ground voltage Vg.

As shown in FIG. 14, the address pulse has a rise time Tᵣᵢₛₑ in which the address pulse increases from the ground voltage Vg to the address voltage Va, an address voltage time Tₜₒₚ, and a fall time T_{fall} in which the address pulse decreases from the address voltage Va to the ground voltage Vg. Since the address pulse should be continuously applied in order to select the discharge cells to be turned on in sequential rows, the duration for applying the ground voltage Vg is substantially 0 μs. For example, a conventional address pulse can have a rise time Tᵣᵢₛₑ of 0.3 μs, a fall time T_{fall} of 0.3 μs, an address voltage time Tₜₒₚ of 1 μs. Thus, the conventional address pulse has a cycle time of 1.6 μs, a frequency of 625 kHz, and a duty ratio of 100%. However, the address pulse generated in the driver according to the present invention can have a rise time Tᵣᵢₛₑ of 0.05 μs, a fall time T_{fall} of 0.05 μs, and an address voltage time Tₜₒₚ of 1 μs. Thus, the address pulse according to the present invention has a cycle time of 1.1 μs, a frequency of 909 kHz, and a duty ratio of 100%. In comparison with the conventional address pulse, the rise time Tᵣᵢₛₑ and the fall time T_{fall} can be reduced, and the cycle time of the address pulse, including the rise time Tᵣᵢₛₑ, the address voltage time Tₜₒₚ, and the fall time T_{fall}, can be also reduced. Thus, the address period PA, shown in FIG. 7, can be reduced. As explained above, the number of the scan electrode lines and the sustain electrode lines can be increased, or the available gradient level can be increased, and a plasma display panel may display a higher resolution.

In an apparatus for driving a plasma display panel according to the present invention, it is thus possible to reduce the transient times of the rising and falling edges of the address pulses and sustain pulses by using magnetic switches coupled with energy switching elements in the energy recovering unit.

Also, it is possible to shorten a sustain period in the sustain pulse in which the sustain discharge is performed in the plasma display panel and allocate the reduced time of the sustain period to the address period or the reset period, especially in plasma display panels with an increased number of electrode lines.

In addition, it is possible to shorten an address period by reducing the transient time of the rising and falling edges of the address pulse.

In addition, the number of the sub-fields in a unit frame can be increased. Therefore, a gradient display can be implemented in a higher resolution, and the gradient display performance can be improved.

Furthermore, since the IGBT can be used as an energy switching element, it is possible to use a high discharge voltage in a plasma display device with a high concentration of Xe gas in the discharge cells to achieve improved discharge efficiency.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus for driving a plasma display panel having a plurality of electrodes positioned between a first substrate and a second substrate, the apparatus supplying driving signals to a discharge cell, formed between the first substrate and the second substrate and where at least two electrodes cross with each other, to emit light by generating a discharge in the discharge cell, the apparatus comprising:
a pulse generator to supply a pulse alternating between a first voltage and a second voltage to an electrode; and
an energy recovering unit to store a charge from the discharge cell when the pulse decreases from the second voltage to the first voltage or to output the charge to the discharge cell when the pulse increases from the first voltage to the second voltage, the energy recovering unit comprises a magnetic switch with variable inductance to perform a first switching operation,
wherein the magnetic switch is positioned along a current path of the charge between the energy recovery unit and the discharge cell, and the variable inductance is dependent upon a current flowing through the magnetic switch.

2. The apparatus of claim 1, wherein the energy recovering unit further comprises:
an energy storage capacitor to recover and store the charge from the discharge cell or to output the charge to the discharge cell; and
a first energy switching element coupled with the energy storage capacitor and the discharge cell, the first energy switching element to control the operation of the energy storage capacitor by performing a second switching operation.

3. The apparatus of claim 2, wherein the charge flows between the energy storage capacitor and the panel based on the second switching operation.

4. The apparatus of claim 3, wherein the variable inductance induces a counter electromotive force to interfere with the charge flow, and the magnetic switch is turned on when the current exceeds a critical value and turned off when the current is less than the critical value.

5. The apparatus of claim 4, wherein the first energy switching element includes an insulated gate bipolar transistor (IGBT).

6. The apparatus of claim 5, wherein the first energy switching element is turned on before the pulse starts to increase from the first voltage.

7. The apparatus of claim 5, wherein the first energy switching element is turned on in advance before the pulse starts to decrease from the second voltage.

8. The apparatus of claim 1, wherein the pulse generator comprises:
a first voltage source to supply the first voltage;
a first switching element coupled in series with the first voltage source and the discharge cell;
a second voltage source to supply the second voltage;
a second switching element coupled in series with the second voltage source and the discharge cell.

9. The apparatus of claim 8, wherein the pulse increases from the first voltage to the second voltage when the magnetic switch and the first energy switching element turn on, the pulse maintains the second voltage when the second switching element turns on, the pulse decreases from the second voltage to the first voltage when the magnetic switch and the first energy switching element turn on, and the pulse maintains the first voltage when the first switching element turns on.

10. The apparatus of claim 1, wherein the plurality of electrodes comprise:
a first electrode;
a second electrode disposed in parallel with the first electrode; and
a third electrode crossing with the first electrode and second electrode.

11. The apparatus of claim 10, wherein the pulse is applied to the first electrode.

12. The apparatus of claim 11, wherein the pulse is a sustain pulse for generating a sustain discharge in the discharge cell.

13. The apparatus of claim 10, wherein the pulse is applied to the third electrode.

14. The apparatus of claim 13, wherein the pulse is an address pulse for generating an address discharge in the discharge cell.

15. The apparatus of claim 1, wherein the first voltage is a ground voltage.

16. The apparatus of claim 2, further comprising:
a second energy switching element coupled with the energy storage capacitor and the discharge cell and coupled in parallel with the first energy switching element,
wherein the energy recovering unit stores the charge from the discharge cell when the second energy switching element is on and the first energy switching element is off, and the energy recovering unit outputs the charge to the discharge cell when the second energy switching element is off and the first energy switching element is on.

17. The apparatus of claim 16, wherein the second energy switching element includes an insulated gate bipolar transistor.

18. An apparatus for driving a plasma display panel having a plurality of first electrodes, a plurality of second electrodes disposed in parallel with the first electrodes, and a plurality of third electrodes disposed to cross with the plurality of first electrodes and the plurality of second electrodes and form discharge cells, the apparatus supplying driving signals to the discharge cells, the apparatus comprising:
a sustain pulse generator to supply a sustain pulse alternating between a sustain discharge voltage and a ground voltage to the first electrode and the second electrode to generate a sustain discharge in the discharge cell; and
an energy recovering unit to store a charge from the discharge cell when the sustain pulse decreases from the sustain discharge voltage to the ground voltage or to output the charge to the discharge cell when the sustain pulse increases from the ground voltage to the sustain discharge voltage,
wherein the energy recovering unit comprises:
an energy storage capacitor to recover and store the charge from the discharge cell or to output the charge to the discharge cell;
an insulated gate bipolar transistor (IGBT) to control operation of the energy storage capacitor; and
a magnetic switch with variable inductance to perform a first switching operation, the magnetic switch determining a rise time required for the sustain pulse to rise from the ground voltage to the sustain discharge voltage or a fall time required for the sustain pulse to fall from the sustain discharge voltage to the ground voltage based on an LC resonance of the magnetic switch inductance and discharge cell capacitance,
wherein the variable inductance is dependent upon a current flowing between the energy storage capacitor and the discharge cell by a switching operation of the IGBT and through the magnetic switch.

19. An apparatus for driving a plasma display panel having a plurality of first electrodes, a plurality of second electrodes disposed in parallel with the first electrodes, and a plurality of third electrodes disposed to cross with the plurality of first electrodes and plurality of second electrodes and form discharge cells, the driving apparatus supplying driving signals to the discharge cells, the apparatus comprising:
an address pulse generator supplying an address pulse alternating between a ground voltage and an address voltage to the third electrode to generate address discharge in the discharge cell; and
an energy recovering unit to store a charge from the discharge cell when the address pulse decreases from the address voltage to the ground voltage or to output the charge to the discharge cell when the address pulse increases from the ground voltage to the address voltage,
wherein the energy recovering unit comprises:
an energy storage capacitor to recover and store the charge from the discharge cell or to output the charge to the discharge cell;
an insulated gate bipolar transistor (IGBT) to control operation of the energy storage capacitor; and
a magnetic switch with variable inductance to perform a first switching operation, the magnetic switch determining a rise time required for the address pulse to rise from the ground voltage to the address voltage or a fall time required for the address pulse to fall from the address voltage to the ground voltage based on an LC resonance of the magnetic switch inductance and discharge cell capacitance,
wherein the variable inductance is dependent upon a current flowing between the energy storage capacitor and the discharge cell by a switching operation of the IGBT and through the magnetic switch.
